(19) United States
(12) Patent Application Publication
(10) Pub. No.: US 2025/0021826 A1
(43) Pub. Date: Jan. 16, 2025

(54) Low-Rank Compression of Neural Networks

(71) Applicant: Samsung Electronics Co., Ltd., Suwon-si (KR)

(72) Inventors: Shangqian Gao, Mountain View, CA (US); Ting Hua, Cupertino, CA (US); Yen-Chang Hsu, Fremont, CA (US); Yilin Shen, Mountain View, CA (US); Hongxia Jin, San Jose, CA (US)

(21) Appl. No.: 18/629,162

(22) Filed: Apr. 8, 2024

Related U.S. Application Data
(60) Provisional application No. 63/526,381, filed on Jul. 12, 2023.

(51) Int. Cl. G06N 3/0985; G06N 3/0495

(52) U.S. Cl. CPC G06N 3/0985; G06N 3/0495

(57) ABSTRACT

In one embodiment, a method includes accessing at least a portion of a training dataset for a trained neural network that includes multiple layers, where each layer includes a number of parameters, and where the training dataset includes multiple training samples that each include an input and a ground-truth output used to train the trained neural network. The method further includes training a hypernetwork to generate a layer-specific compression mask for each of one or more of the multiple layers of the trained neural network. The method further includes generating, by the trained hypernetwork, a final layer-specific compression mask for the trained neural network and compressing the trained neural network by reducing, for each of the one or more layers of the neural network, the number of parameters of that layer according to the final layer-specific compression mask.

### PRIORITY CLAIM

This application claims the benefit under 35 U.S.C. § 119 of U.S. Provisional Patent Application No. 63/526,381 filed Jul. 12, 2023, which is incorporated by reference herein.

### TECHNICAL FIELD

This application generally relates to compression of trained neural networks.

### BACKGROUND

Singular Value Decomposition (SVD) and its weighted variants can be used to compress neural networks, including large-language models. For example, transformer-based models are often used for various natural language processing (NLP) tasks, such as text classification, question answering, and summarization. However, the size of these transformer-based models often scales up to millions or billions of parameters, and that is especially true for large language models. The huge number of parameters make neural networks very resource intensive from a computational perspective. For example, a neural network with many parameters limits the ability of the model to be deployed on relatively resource-limited computing devices, such as mobile phones.

### BRIEF DESCRIPTION OF THE DRAWINGS

FIG. 1 illustrates an example of low-rank factorization using SVD for a single linear layer of a neural network.

FIG. 2 illustrates an example method for generating a layer-specific compression mask for a trained neural network.

FIG. 3 provides an example illustration of the compression of a particular layer of a transformer block.

FIG. 4 illustrates an example comparison of uniform-rank compression with a layer-specific and operation-specific model compression based on mask m.

FIG. 5 illustrates an example computing system.

### DESCRIPTION OF EXAMPLE EMBODIMENTS

Low-rank factorization can be applied to any linear layer in a neural network model, and can be applied to model weights and to embedding layers. For example, transformer-based models have two core operations: self-attention layers and feed-forward layers. Both of these two operations are built on linear layers, which makes them amenable to compression techniques such as low-rank weight factorization with singular value decomposition (SVD) or its variants. With low-rank weight factorization, a large linear layer can be decomposed into two small linear layers without modification of other operations. In addition, low-rank weight factorization is orthogonal to other compression techniques, like structural pruning, quantization, knowledge distillation, and so on.

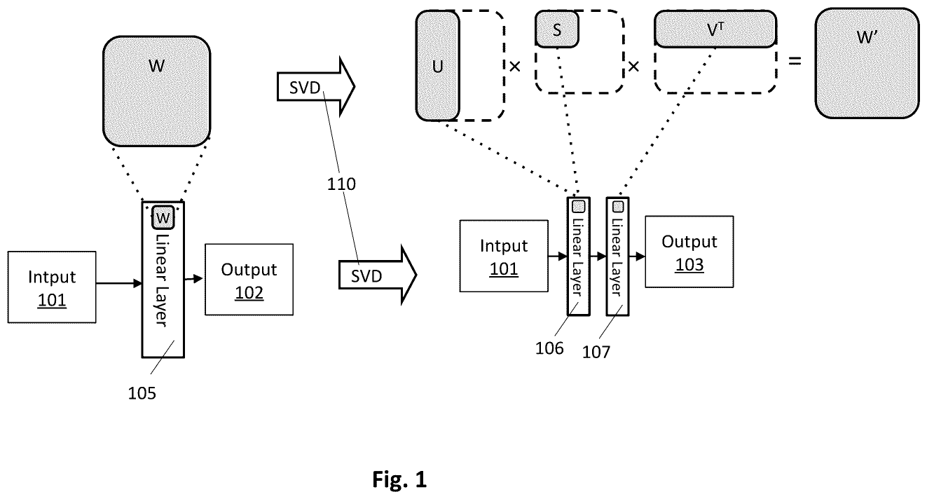

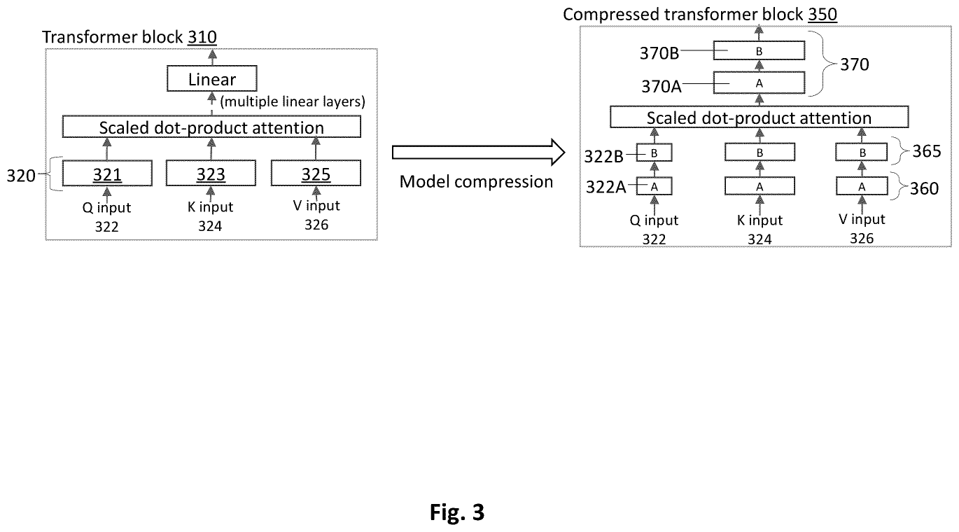

FIG. 1 illustrates an example low-rank factorization using SVD for a single linear layer 105 of a neural network. For example, as illustrated with respect to FIG. 3, linear layer 105 may be a layer of a transformer model, which is composed of N transformer blocks, with each block containing multiple linear layers. In the example of FIG. 1, input 101 is applied to linear layer 105, which operates on input 101 to produce output 102. Linear layer 105 can be represented as a matrix W, in which the matrix elements of W are the parameters (e.g., model weights) corresponding to layer 105, which define the output of the linear layer given some input. Linear layer and matrix W may be represented by SVD technique 110. SVD technique 110 decomposes matrix W into matrices U, S, and V^{T}. Likewise, linear layer 105 may be represented as two linear layers: layer 106, which corresponds to the parameters defined by matrices U and S, and layer 107, which corresponds to the parameters defined by matrix V^{T}. The product of matrices U, S, and V^{T} result in matrix W′, which approximates (but does not necessarily equal) matrix W. Likewise, providing input 101 to linear layers 106 and 107 results in output 103, which approximates (but does not necessarily equate to) output 102. Matrix S is the singular value matrix, which has elements 1 or 0 on the diagonal and 0 everywhere else. Here, the “rank” of matrix S corresponds to the space spanned by that matrix (i.e., to the number of non-zero diagonal elements in the matrix). SVD can compress matrix W by reducing the number of diagonal elements in matrix S, which removes corresponding vectors in matrices U and V^{T} (e.g., turning a “1” in matrix S to a “0” will reduce the elements in matrix W′). As a result, layers 106 and 107 have fewer parameters than does layer 105, while still retaining a representation of the information in layer 105.

More formally, SVD decomposes a matrix W∈ [symbol] ^{M×N} into three matrices:

$$W = USV \approx {U}_{r} {S}_{r} {V}_{r} , \qquad ( 1 )$$

where the orthogonal matrix U∈ [symbol] ^{M×M} is the left singular vectors, and the orthogonal matrix V∈ [symbol] ^{N×N} is the right left singular vectors. S is a diagonal matrix of non-zero singular values Diag(s)=Diag(σ₁, σ₂, . . . , σ_{N}) (assume M≥N), where σ₁≥σ₂≥ . . . σ_{N}. Uᵣ, Sᵣ, Vᵣ represent the truncated matrices with rank r and approximate the original matrix. With SVD, the computation of a linear layer in a neural network can be rewritten as below with input data X∈ [symbol] ^{B×M}, weight matrix W∈ [symbol] ^{M×N}, bias b∈ [symbol] ^{1×N}:

$$Y = XW + b \approx X ( US ) {V}^{T} + b . \qquad ( 2 )$$

Standard SVD can be improved by multiplying a weighting matrix I_{w} with W, and this weighting matrix can be computed in many different ways, such as using Fisher Information, Importance Estimation, etc. Weighted SVD often performs better than non-weighted SVD when compressing models. The weighting matrix I_{w} is a diagonal matrix where the importance of each weight is summed within each column or row. Then, after applying I_{w}, equation (2) becomes:

$$Y = XW + b \approx X [ {I}_{w}^{- 1} ( {U}^{′} {S}^{′} ) {V}^{{′}^{T}} ] + b . \qquad ( 3 )$$

where U′, S′, and V′ come from the weighted SVD decomposition of I_{w}W=U′S′V′. Note that by using SVD or its weighted variants, one can compress pre-trained models, which is important since the training costs of the current large language models is quite high, and training from scratch can be very expensive.

Using conventional SVD techniques to compress neural networks can result in a significant performance drop of the compressed model, which may be because SVD focuses on the reconstruction error, and a lower reconstruction error is not equivalent to higher performance. Applying the Fisher Information matrix to re-weight the weight matrix may be done so that the factorization results can capture information from both the task and the reconstruction error. Empirically, Fisher Information weighted SVD (FWSVD) performs better than does typical SVD techniques alone. Other importance scores, like first-order Taylor expansion, can also be used to re-weight a weight matrix representing a linear layer of a neural network model. Although weighted SVD achieves good performance, both SVD and weighted SVD treat all operations in different layers uniformly, and thus the number of ranks (which, as explained below, relates to the number of model parameters defined by SVD) is the same for all weight matrices in the neural-network model.

In contrast to the techniques discussed above, the systems and methods described herein generate a set of layer-specific masks that allocate varying amounts of compression to each layer of a trained neural network, and in particular embodiments, to each operation within a layer. Not all operations in a trained model are equally important for performing downstream (inferencing) tasks, and therefore some operations (i.e., those operations that most impact model performance) should be given more capacity (relatively less compression) than others. The techniques described herein allocate a relatively larger number of ranks (the sum of elements of the binary mask) for relatively more important operations. As a result, the compressed model is both more accurate and can be made smaller by providing relatively more compression for relatively less important operations.

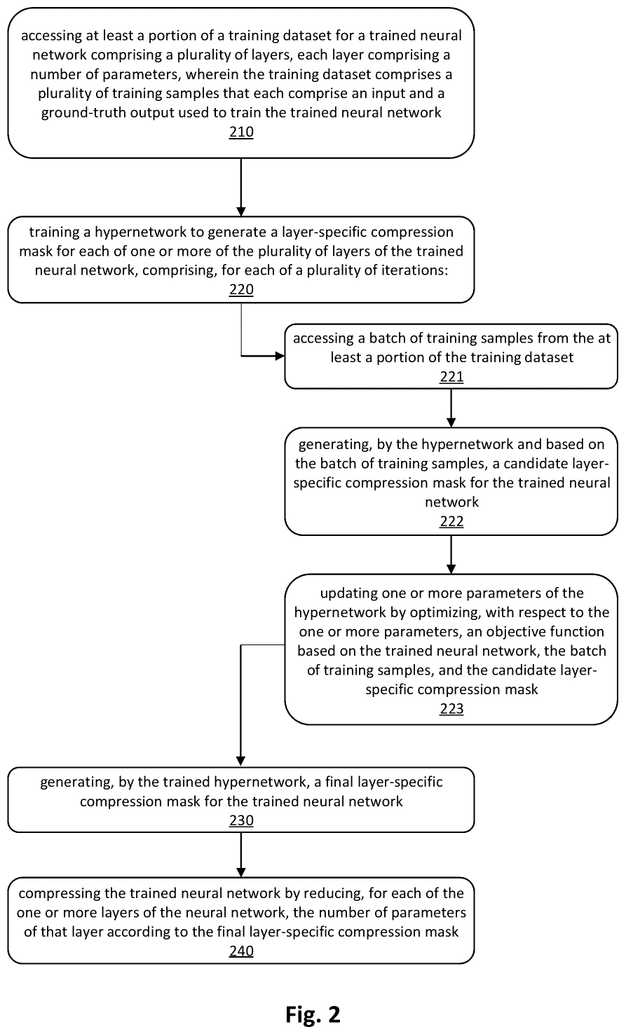

FIG. 2 illustrates an example method for generating a layer-specific compression mask for a trained neural network. As explained herein, the layer-specific compression mask is a set of masks, at least one for each of one or more layers of the neural network, and the rank of the mask is tuned specifically to the corresponding layer of the neural network. As a result, the layer-specific compression mask reduces the parameters of the neural network will maintaining the most important information (parameters) of the neural network on a layer-by-layer and, in particular embodiments, on an operation-by-operation decision basis.

Step 210 of the example method of FIG. 2 includes accessing at least a portion of a training dataset for a trained neural network that includes a plurality of layers, each layer comprising a number of parameters, where the training dataset includes a plurality of training samples that each comprise an input and a ground-truth output used to train the trained neural network. For example, a trained neural network may be a large language model or computer-vision model (e.g., a computer-vision model for identifying one or more objects in an image). The training dataset is the set of training data (training inputs and labelled ground-truth) used to train the neural network. The trained neural network has a number of layers, which contain the parameters of the neural network, and as explained above, these parameters may range in the millions or billions.

Step 220 of the example method of FIG. 2 includes training a hypernetwork to generate a layer-specific compression mask for each of one or more of the plurality of layers of the trained neural network. Step 220 includes performing steps 221-223 of the example method of FIG. 2 for each of a number of training iterations.

The hypernetwork is made of linear layers and Bi-GRUs. The architecture of the hypernetwork is illustrated in the following table:

Input z
Bi-GRU(32,64)→ LayerNorm→ GeLU
Denseₗ (128, Nₗ) → Outputs oₗ, l=1, ^{. . .} , L

Input z to the hypernetwork is initially sampled from a normal distribution, and it is then fixed during training. Outputs oₗ of the hypernetwork are continuous values, and a mask mₗ for a given layer corresponds to the output oₗ as follows:

$${m}_{l} = round ( sigmoid ( ( {o}_{l} + g + b ) / τ ) ) \qquad ( 4 )$$

where sigmoid(⋅) is the sigmoid function, round(⋅) is the rounding function, g is sampled from Gumbel distribution (g˜Gumbel(0, 1)), b is a constant value to make sure the hypernetwork starts from the full rank, and τ is a temperature hyper-parameter. For example, particular embodiments may use τ=0.4 and b=3.0. As shown in equation 4, straight-through Gumbel-Sigmoid are used to produce the final binary vector m, which is the layer-specific compression mask for a particular neural network. The hypernetwork is made up of GRU's and multilayer perceptrons (MLPs). The GRUs can be used to learn interactions between different layers, and MLPs are used to map GRU outputs to individual operations of different sizes. Given an input z, the hypernetwork HN parameterized by the parameters θ generates a mask according to:

$$m = HN ( z ; θ ) \qquad ( 5 )$$

In equation (2), the diagonal matrix S contains the singular values of the SVD. When a singular value (i.e. a value on the diagonal of S) is equal to zero, then the corresponding vectors from U and V are effectively removed from the approximation matrix W′. The singular values are typically non-zero. Compressing a neural network by applying the mask m, which may be a binary mask (i.e., m∈{0,1}), to the diagonal matrix results in truncated singular value vector ŝ:

$$\hat{s} = m ⊙ s \qquad ( 6 )$$

where s is the singular-value vector, and S=Diag(s). After applying m, equation 2 becomes:

$$Y = X ( U Diag ( \hat{s} ) ) {V}^{T} + b \qquad ( 7 )$$

which inserts the mask m into the forward/backward calculation of a neural-network layer under SVD. The gradients with respect to m can then be calculated during regular backpropagation. This approach provides custom rank selection for individual operations with each layer of a neural network, which creates large flexibility to allocate different ranks for different operations, so that relatively more parameters can be retained for relatively more important operations for a given neural network.

Returning to the method of FIG. 2, step 220 of training a hypernetwork to generate the layer-specific compression mask m for a given neural network involves performing steps 221-223 for a number of iterations. The number of iterations may be specified by a user, by system resources (e.g., by an amount of time spent on training), by a performance metric (e.g., if training suitably converges), or by any suitable combination thereof.

Step 221 includes accessing a batch of training samples from the portion of the training dataset used to train the neural network. Step 222 includes generating, by the hypernetwork and based on the batch of training samples, a candidate layer-specific compression mask for the trained neural network. The candidate layer-specific compression mask m is generated by the hypernetwork according to equation 5, above. Step 223 includes updating one or more parameters θ of the hypernetwork by optimizing, with respect to the one or more parameters, an objective function based on the trained neural network, the batch of training samples, and the candidate layer-specific compression mask. In particular embodiments, the optimization of step 223 may include one or more regularization terms. For example, particular embodiments may update one or more parameters θ of the hypernetwork during hypernetwork training by minimizing, with respect to the one or more parameters, the following:

$${min}_{θ} ∠ ( f ( x ; m ) , y ) + λℛ ( pT ( m ) , {T}_{total} ) + γ \frac{1}{L} {\sum }_{l = 1}^{N} {ℛ}_{align} ( {m}_{l} ) \qquad ( 8 )$$

where x, y are the training input and its corresponding ground-truth label; f(⋅; m) is the model parameterized by the mask m; λ (e.g., λ=16) controls the regularization weights for the parameter regularization [symbol] ; γ (e.g., γ=10) controls the regularization weights of [symbol] _{align}; Tₜₒₜₐₗ is the total number of the parameters; and p is the persevered ratio of parameters (i.e., compression rate), which may be specified by a user (e.g., via an instruction to compress a model by 20%, etc.). T(m) is the number of parameters decided by the number of ranks of each operation. Taking the lth weight matrix as an example, the number of parameters for that weight matrix is determined by: T(mₗ)=(Mₗ+Nₗ)*(1^{T}mₗ), where Mₗ and Nₗ is the number of inputs and outputs dimensions for lth weight matrix. In the example implementation of equation 8, L(f(x; m), y) is the objective function, λ [symbol] (pT(m), Tₜₒₜₐₗ) is a parameter regularization term, and

$$\frac{1}{L} {\sum }_{l = 1}^{N} {ℛ}_{align} ( {m}_{l} )$$

is an alignment regularization term. The parameter regularization term [symbol] is defined by [symbol] (a,b)=log(max(a,b)/b). In equation 8, optimization is performed by minimizing the function shown with respect to parameters θ, but this disclosure contemplates that optimization may equivalently be performed by other operations (e.g., by maximizing, with respect to parameters θ, the negative of equation 8).

In particular embodiments, during optimization, model weights may be frozen so that the number of ranks of each layer can be evaluated effectively. Algorithm 1, below, illustrates a one-shot compression framework in accordance with the example method of FIG. 2 and using the optimization shown in equation 8. As explained below, after learning m, particular embodiments compress the trained neural network based on the number of ranks specified by 1^{T}m rather than by the indices of m.

Algorithm 1: Adaptive Rank Selection

| Input - a sub-dataset for training the HN: | | |
|---|---|---|
| D_{HN}; remained rate of parameters: p; | | |
| hyper-parameter: λ,γ; HN training | | |
| iterations: Nᵢₜₑᵣ; a pre-trained model: f; | | |
| the hypernetwork HN parameterized by θ | | |
| for i := 1 to Nᵢₜₑᵣ do | | |
| \| | for a mini-batch (x,y) in D_{HN}do | |
| \| | \| | 1. Generate m from HN with Eq. 5. |
| \| | \| | 2. Calculate the parameter regularization term [symbol] (pT(m), Tₜₒₜₐₗ). |
| \| | \| | 3. Calculate the alignment regularization term [symbol] _{align}. |
| \| | \| | 4. Calculate gradients w.r.t θ by minimizing Eq. 8 and update θ. |
| \| | end | |

end
Compress the model based on the number of ranks:
US = (US)_{[:,:1}_{^{T}}_{m]}, V = V_{[:,:1}_{^{T}}_{m]}.
Return the resulting model for fine-tuning.

Step 230 of the example method of FIG. 2 includes generating, by the trained hypernetwork, the final layer-specific compression mask for the trained neural network. In other words, once training of the hypernetwork is complete for a given trained neural network, the result is a final mask m for compressing the trained neural network. Step 240 of the example method of FIG. 2 then includes compressing the trained neural network by reducing, for each layer of the one or more layers of the neural network, the number of parameters of that layer according to the layer-specific compression mask. For example, the mask may be used as in equations 5 and 6 to compress a trained neural network by removing, for each layer, the parameters specified by applying the mask to s.

In particular embodiments, rather than directly applying the mask m to compress the model in step 240, the number of ranks 1^{T}m specified by m is instead used to compress the trained neural network. For example, m gives the number of ranks and the exact positions (specified by the indices of m) for each layer of the trained neural network. SVD and its weighted version rank the importance of each singular value based on that value's magnitude. However, the exact positions generated by the mask m may not be continuous (i.e., top-k like). In particular embodiments, directly compressing a trained neural network based on indices will create difficulties during fine-tuning due to the non-continuous selection of the ranks, and this deteriorates the structure of SVD. A solution is to select the top 1^{T}mₗ important ranks from the original weight matrix, meaning that only the number of ranks (1^{T}mₗ) produced by the mask m is used, and the indices are not used during step 230. mₗ is the mask for the lth layer of the trained neural network, and 1^{T}mₗ is the sum of mₗ (i.e., the sum of the elements of mₗ, which in this example is a binary mask for layer l), which is equivalent to the number of ranks found by mₗ. While this approach may be used to improve fine tuning, it creates a gap between the learned masks and the compressed model based on the number of ranks, which can result in a worse compressed neural network prior to fine-tuning. This gap can be defined by the following function:

$${‖ {m}_{l} ⊙ s - {m}_{l}^{′} ⊙ s ‖}_{2}^{2} \qquad ( 9 )$$

where m′ₗ is also a binary mask but is a sorted vector such that the n “1” entries in m′ₗ are in the top-n elements of

$${m}_{l}^{′} , {m}_{{l}_{[ : {1}^{T} {m}_{l} ]}}^{′} = 1 ,$$

and the rest of the elements of m′ₗ equal 0. Particular embodiments reduce this gap to make the learned mask have more continuous predictions by using an alignment regularization term: [symbol] _{align}(mₗ)=∥mₗ⊙s−m′ₗ⊙s∥₂² on top of the alignment gap. With this regularization, particular embodiments encourage the mask mₗ to be continuous, and this mask can then be seamlessly inserted into the optimization of the hypernetwork. Another choice of defining this gap is ∥mₗ−m′ₗ∥₂², which omits singular values. Compared to ∥mₗ−m′ₗ∥₂², the definition in Eq. 9 will have large weights on large singular values, which encourages elements of mₗ with large singular values to be continuous.

In particular embodiments, the embedding layers of a trained neural network may be pruned and the linear layers (e.g., self-attention layers and feed-forward networks) may be compressed.

In particular embodiments, rather than using a hypernetwork to generate a mask m, element-wise parameterization may be used to generate the mask. However, this approach typically results in slower convergence and poorer performance.

After compression, the compressed trained neural network contains fewer parameters than the original, uncompressed neural network. The compressed, trained neural network may then be deployed on a computing device for its task-specific functions, optionally after any fine tuning on the compressed model's downstream task. For example, a compressed trained neural network for outputting a natural-language description of objects in an image, or a compressed trained neural network for parsing natural-language input (e.g., as for a voice assistant), may be deployed on a smartphone, a personal computer, a tablet, a TV, etc.

As explained above, the mask m identifies parameters for pruning from a trained neural network on a layer-by-layer basis. Moreover, in particular embodiment, the pruning identified by a mask m for each layer may also vary for each operation within a layer. FIG. 3 illustrates an example illustration of the compression of a particular layer of a transformer block. A transformer includes repeated transformer blocks, where each block is a collection of linear layers. Transformer block 310 illustrates an uncompressed transformer block. Transformer block 310 includes multiple linear layers, and each layer may include multiple operations. For example, layer 320 in transformer block 310 includes an operation 321 on query input 322, an operation 323 on key operation 324, and an operation 325 on value input 326. Transformer block 350 illustrates an example of transformer block 310 after compression. As illustrated in FIG. 3 and explained in connection with FIG. 1, SVD is used to decompose each operation into two linear layers: in block 350, layer 360 corresponds to the parameters defined by matrices U and S (denoted by “A” in FIG. 3) for each operation, and layer 365 corresponds to the parameters defined by matrix V^{T} (denoted by “B” in FIG. 3) for each operation.

Layers 370 of block 350 partially illustrates another linear layer in block 350. In block 350, the width of each block/operation in each layer visually illustrates the compression of that operation, e.g., boxes 370A and 370B are wider than boxes 322A and 322B, indicating that operations corresponding to boxes 322A and 322B have been more compressed (have fewer parameters) relative to operations corresponding to boxes 370A and 370B. As illustrated in FIG. 3, the amount of compression may vary among layers and also within operations of a given layer. In contrast, the compression of a neural network using standard or weighted SVD applies the same compression to each layer of the neural network and to each operation within each layer, and therefore does not take into account the relative importance of the model's parameters on model performance.

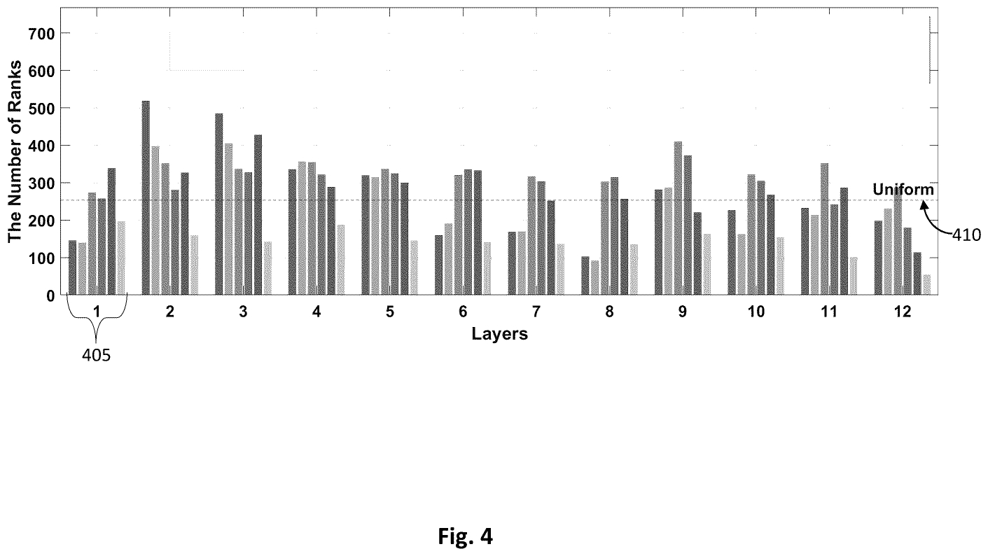

FIG. 4 represents another example illustration comparing the layer-specific and operation-specific model compression based on mask m with the uniform-rank compression of standard SVD. Each layer of neural network is identified by the integers on the x axis in FIG. 4 (e.g., number “1” refers to the first layer, etc.), and each bar within each layer corresponds to an operation with that layer. For example, the six bars in section 405, which collectively correspond to layer 1, each correspond to a particular operation within that layer. The y-axis illustrates the number of ranks corresponding to an operation. As illustrated by line 410 in FIG. 4, standard SVD results in a model that has the same number of ranks for each operation and for each layer. In contrast, compression based on mask m results in a model that has varying rank for each operation within a layer and for operations across layers, and therefore the compressed model is both more efficient (i.e., unnecessary parameters can be removed from a particular operation) and more accurate (i.e., parameters that are relatively important to the model's performance on downstream tasks can be retained).

Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2. Moreover, this disclosure contemplates that some or all of the computing operations described herein, including certain steps of the example method illustrated in FIG. 2, may be performed by circuitry of a computing device described herein, by a processor coupled to non-transitory computer readable storage media, or any suitable combination thereof.

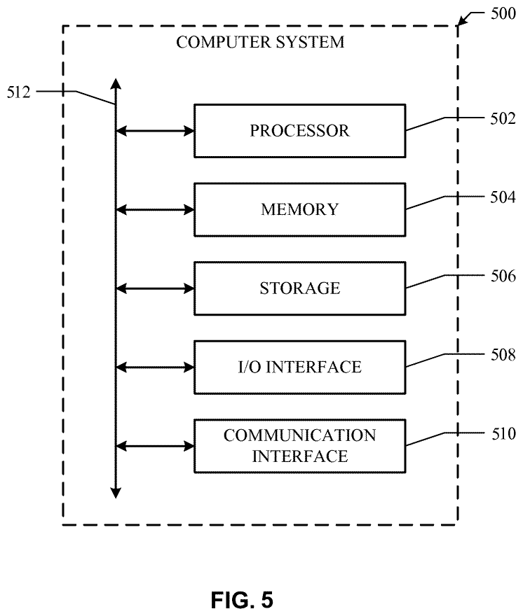

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing at least a portion of a training dataset for a trained neural network comprising a plurality of layers, each layer comprising a number of parameters, wherein the training dataset comprises a plurality of training samples that each comprise an input and a ground-truth output used to train the trained neural network;
training a hypernetwork to generate a layer-specific compression mask for each of one or more of the plurality of layers of the trained neural network, comprising, for each of a plurality of iterations:
accessing a batch of training samples from the at least a portion of the training dataset;
generating, by the hypernetwork and based on the batch of training samples, a candidate layer-specific compression mask for the trained neural network;
updating one or more parameters of the hypernetwork by optimizing, with respect to the one or more parameters, an objective function based on the trained neural network, the batch of training samples, and the candidate layer-specific compression mask;
generating, by the trained hypernetwork, a final layer-specific compression mask for the trained neural network; and
compressing the trained neural network by reducing, for each of the one or more layers of the neural network, the number of parameters of that layer according to the final layer-specific compression mask.

2. The method of claim 1, wherein:
the number of parameters of each layer of the trained neural network are represented by a singular value matrix for that layer; and
compressing the trained neural network comprises zeroing out, based on the layer-specific compression mask, one or more entries in the respective singular value matrix corresponding to a layer.

3. The method of claim 1, wherein the layer-specific compression mask comprises a layer-specific binary mask.

4. The method of claim 1, wherein the trained neural network comprises a trained large-language model.

5. The method of claim 1, wherein the trained neural network comprises a plurality of transformer blocks, each transformer block comprising a plurality of linear layers.

6. The method of claim 5, wherein each of the plurality of linear layers comprises a query matrix, a key matrix, and a value matrix.

7. The method of claim 6, wherein the layer-specific compression mask is further specific to each of the query matrix, the key matrix, and the value matrix of each respective linear layer of the trained neural network.

8. The method of claim 1, wherein updating the one or more parameters of the hypernetwork is further based on an alignment regularization term for each layer-specific mask of the layer-specific compression mask.

9. The method of claim 1, wherein updating the one or more parameters of the hypernetwork is further based on a parameter regularization function.

10. The method of claim 1, wherein updating the one or more parameters of the hypernetwork comprises optimizing, with respect to the one or more parameters θ, the following function:
$${min}_{θ} ∠ ( f ( x ; m ) , y ) + λℛ ( pT ( m ) , {T}_{total} ) + γ \frac{1}{L} {\sum }_{l = 1}^{N} {ℛ}_{align} ( {m}_{l} ) .$$

11. The method of claim 1, further comprising deploying the compressed trained neural network on a client computing device.

12. One or more non-transitory computer readable storage media storing instructions and coupled to one or more processors that are operable to execute the instructions to:
access at least a portion of a training dataset for a trained neural network comprising a plurality of layers, each layer comprising a number of parameters, wherein the training dataset comprises a plurality of training samples that each comprise an input and a ground-truth output used to train the trained neural network;
train a hypernetwork to generate a layer-specific compression mask for each of one or more of the plurality of layers of the trained neural network, comprising, for each of a plurality of iterations:
access a batch of training samples from the at least a portion of the training dataset;
generate, by the hypernetwork and based on the batch of training samples, a candidate layer-specific compression mask for the trained neural network;
update one or more parameters of the hypernetwork by optimizing, with respect to the one or more parameters, an objective function based on the trained neural network, the batch of training samples, and the candidate layer-specific compression mask;
generate, by the trained hypernetwork, a final layer-specific compression mask for the trained neural network; and
compress the trained neural network by reducing, for each of the one or more layers of the neural network, the number of parameters of that layer according to the final layer-specific compression mask.

13. One or more non-transitory computer readable storage media embodying a compressed, trained neural network made by a process comprising the steps of:
accessing at least a portion of a training dataset for a trained neural network comprising a plurality of layers, each layer comprising a number of parameters, wherein the training dataset comprises a plurality of training samples that each comprise an input and a ground-truth output used to train the trained neural network;
training a hypernetwork to generate a layer-specific compression mask for each of one or more of the plurality of layers of the trained neural network, comprising, for each of a plurality of iterations:
accessing a batch of training samples from the at least a portion of the training dataset;
generating, by the hypernetwork and based on the batch of training samples, a candidate layer-specific compression mask for the trained neural network;
updating one or more parameters of the hypernetwork by optimizing, with respect to the one or more parameters, an objective function based on the trained neural network, the batch of training samples, and the candidate layer-specific compression mask;
generating, by the trained hypernetwork, a final layer-specific compression mask for the trained neural network; and
compressing the trained neural network by reducing, for each of the one or more layers of the neural network, the number of parameters of that layer according to the final layer-specific compression mask.

14. The media of claim 13, wherein:
the number of parameters of each layer of the trained neural network are represented by a singular value matrix for that layer; and
compressing the trained neural network comprises zeroing out, based on the layer-specific compression mask, one or more entries in the respective singular value matrix corresponding to a layer.

15. The media of claim 13, wherein the trained neural network comprises a plurality of transformer blocks, each transformer block comprising a plurality of linear layers.

16. The media of claim 15, wherein each of the plurality of linear layers comprises a query matrix, a key matrix, and a value matrix.

17. The media of claim 16, wherein the layer-specific compression mask is further specific to each of the query matrix, the key matrix, and the value matrix of each respective linear layer of the trained neural network.

18. The media of claim 13, wherein updating the one or more parameters of the hypernetwork is further based on an alignment regularization term for each layer-specific mask of the layer-specific compression mask.

19. The media of claim 13, wherein updating the one or more parameters of the hypernetwork is further based on a parameter regularization function.

20. The media of claim 13, wherein updating the one or more parameters of the hypernetwork comprises optimizing, with respect to the one or more parameters θ, the following function:
$${min}_{θ} ∠ ( f ( x ; m ) , y ) + λℛ ( pT ( m ) , {T}_{total} ) + γ \frac{1}{L} {\sum }_{l = 1}^{N} {ℛ}_{align} ( {m}_{l} ) .$$
